(19) United States
(12) Patent Application Publication
(10) Pub. No.: US 2012/0043926 A1
(43) Pub. Date: Feb. 23, 2012

(54) Power Management Device, Power Management Method and Portable Electronic Device

(76) Inventors: Chien-Liang Chen, New Taipei City (TW); Chun-Ta Lee, New Taipei City (TW)

(21) Appl. No.: 13/175,959

(22) Filed: Jul. 5, 2011

(30) Foreign Application Priority Data
Aug. 19, 2010 (TW) 099127708

(51) Int. Cl. H02J 7/00; H02J 3/14

(52) U.S. Cl. 320/107; 307/39

(57) ABSTRACT

A power management device for a portable electronic device includes a sensing unit, coupled between a power supply and a system circuit of the portable electronic device, for sensing current outputted from the power supply to the system circuit, to generate a sensing signal, and a control unit, coupled between the sensing unit and a charger module of the portable electronic device, for indicating the charger module to stop charging when the sensing signal indicates that current outputted from the power supply to the system circuit is greater than a predetermined value.

### BACKGROUND OF THE INVENTION

1. Field of the Invention

The present invention relates to a power management device, power management method and portable electronic device, and more particularly, to a power management device, power management method and portable electronic device capable of reducing power consumption timely and avoiding system failures.

2. Description of the Prior Art

Due to the variation of business models and the advancement of technology, manufacturers of consumer electronic products usually develop products with different functionalities or prices to meet different needs. Take computer systems for example, some aim for high performance, such as spectacular audio/video experiences, unparalleled computing speed, etc., while others appeal to day-to-day routines, such as word processing and web browsing, with low prices. In such a situation, the more product lines are, the more difficult the stocking management is.

For example, a laptop with power consumption set to 90 watts in a basic input/output system (BIOS) thereof, yet equipped with a 65-watt power supply, may result from a wrongly configured BIOS or an assembling mistake. In such a situation, when a customer uses the laptop to perform heavy computing power tasks, such as playing video games or performing imaging processing, the system may consume more than 65 watts because the BIOS configuration is set to 90 watts. When the power consumption of the system surpasses the maximum power that the power supply can provide, i.e. 65 watts, the power supply will issue an error alert which suspends the system and requires a reboot procedure. In other words, when the BIOS is not properly configured or the system equips with a wrong make of power supply, the power supply cannot match the system, such that the laptop suspends and requires a reboot procedure upon performing the heavy computing power tasks. A flaw with this magnitude compromises convenience of the customer, and discredits the manufacturers.

Therefore, in order to increase the flexibility on the stocking management, it is necessary to develop a redress scheme for improving the shortcomings of the prior art.

### SUMMARY OF THE INVENTION

It is therefore a primary objective of the present invention to provide power management device, power management method using the same and portable device using the same.

An embodiment of the invention discloses a power management device for a portable electronic device, which comprises a sensing unit, coupled between a power supply and a system circuit of the portable electronic device, for sensing a current outputted from the power supply to the system circuit, to generate a sensing signal; and a control unit, coupled between the sensing unit and a charger module of the portable electronic device, for indicating the charger module to stop charging when the sensing signal indicates that the current outputted from the power supply to the system circuit is greater than a predetermined value.

An embodiment of the invention further discloses a portable electronic device, which comprises a rechargeable battery, for storing electric energy; a charger module, for charging the rechargeable battery; a power supply, for converting an alternating-current (AC) power source to a direct-current (DC) power source; a system circuit, driven by the electric energy stored in the rechargeable battery or the DC power source outputted from the power supply; and a power management device comprising a sensing unit, coupled between the power supply and the system circuit, for sensing current of the DC power source outputted from the power supply to the system circuit, to generate a sensing signal; and a control unit, coupled between the sensing unit and the charger module, for indicating the charger module to stop charging the rechargeable battery when the sensing signal indicates that the current outputted from the power supply to the system circuit is greater than a predetermined value.

An embodiment of the invention further discloses a method of power management for a portable electronic device, which comprises steps of sensing current outputted from a power supply of the portable electronic device to a system circuit of the portable electronic device, to generate a sensing signal; and indicating a charger module of the portable electronic device to stop charging when the sensing signal indicates that the current outputted from the power supply to the system circuit is greater than a predetermined value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a portable electronic device according to an embodiment of the invention.

FIG. 2 is a schematic diagram of a control unit shown in FIG. 1 according to an embodiment of the invention.

FIG. 3 is a schematic diagram of a power management procedure according to an embodiment of the invention.

### DETAILED DESCRIPTION

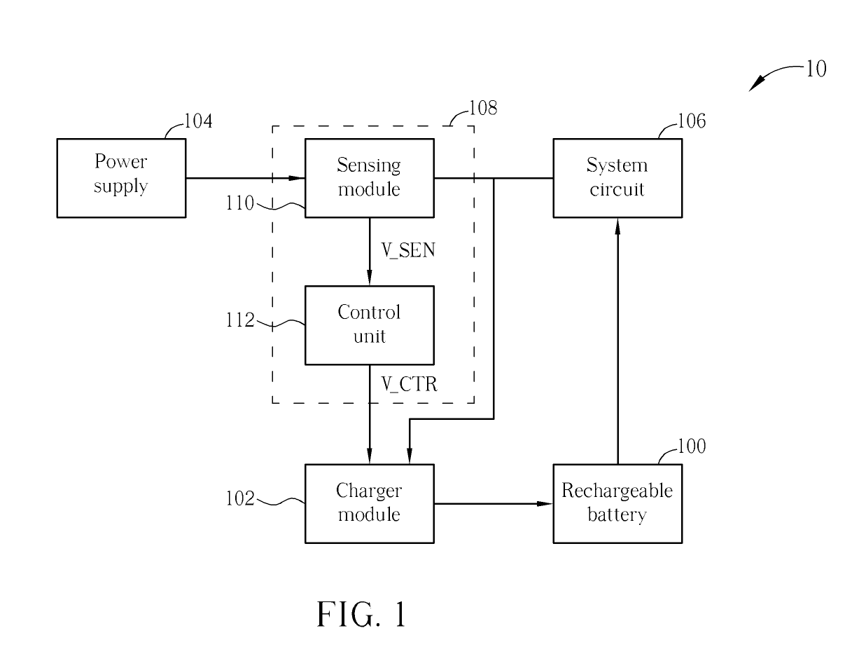

Please refer to FIG. 1, which illustrates a schematic diagram of a portable electronic device 10 according to an embodiment of the invention. The portable electronic device 10 can be a laptop, an electronic reader, a smart phone, a mobile phone, a portable audio/video player, etc., and has a power management redress scheme to increase flexibility on management. The portable electronic device 10 includes a rechargeable battery 100, a charger module 102, a power supply 104, a system circuit 106 and a power management device 108. The power supply 104 converts an alternating-current (AC) power source to a direct-current (DC) power source, to provide energy for the charger module 102 and the system circuit 106 to function. The charger module 102 charges rechargeable battery 100, to store electric energy. The system circuit 106 is driven by the electric energy stored in the rechargeable battery 100 or the DC power source outputted from the power supply 104, and is utilized for fulfilling functionalities of the portable electronic device 10. The power management device 108 includes a sensing module 110 and a control unit 112 to provide a power management redress scheme. The sensing module 110 is coupled between the power supply 104 and the system circuit 106, and is utilized for sensing a direct current outputted from the power supply 104 to the system circuit 106, to generate a sensing signal V_SEN. The control unit 112 is coupled between the sensing module 110 and the charger module 102, and is utilized for indicating the charger module 102 to stop charging the rechargeable battery 100 when the sensing signal V_SEN indicates that the current outputted from the power supply to the system circuit surpasses a default value. In other words, when the system circuit 106 operates with high power consumption, if the current outputted from the power supply 104 to the system circuit 106 surpasses the default value, the power management device 108 outputs a control signal V_CTR indicating the charger module 102 to stop charging the rechargeable battery 100, so as to reduce the power consumption and prevent the power supply 104 from overloading.

In short, if the power supply 104 does not match power specification of the system circuit 106, e.g. the power consumption of the system circuit 106 is configured to 90 watts but a maximum power that the power supply 104 can provide is 65 watts, the power management device 108 is applicable for the power management redress scheme. Namely, when the current outputted from the power supply 104 to the system circuit 106 surpasses the maximum power, the power management device 108 stops the charger module 102 from charging, to reduce the system power consumption, prevent the power supply 104 from overloading, and ensure the system functions properly. Certainly, if the current outputted from the power supply 104 to the system circuit 106 returns within a normal range, the power management device 108 reinstates the charger module 102 to charge.

Note that, FIG. 1 illustrates a composition of the portable electronic device 10 with functional blocks, when in practice, details and operations should be properly adjusted according to required applications. Take a laptop for example, main components of the system circuit 106 can be a central processing unit (CPU), a mother board, memories, a hard drive, etc., which are driven by the power supply 104 when the power supply 104 is working, and driven by the rechargeable battery 100 when the power supply 104 is not working. However, how to drive the system circuit 106 and the details and operations of the system circuit 106 are utilized for narrating the concept of the invention, devisers should coordinate with the required applications.

On the other hand, the invention is utilized for timely stopping the charger module 102 from charging, to reduce power consumption. However, except for stopping the charger module 102 from charging to reduce power consumption, the power consumption of the system circuit 106 can be reduced by reducing CPU speed, luminance and refreshing rate of a monitor, volume of a speaker, output rate of a video card, etc. In such a situation, the control unit 112 should take an extra route to control the system circuit 106, which should be readily known by those skilled in the art. Namely, stopping the charger module 102 from charging is merely one embodiment of the invention, and other skills utilized for reducing the power consumption of the system circuit 106 are equally applicable for the invention, not limited thereto.

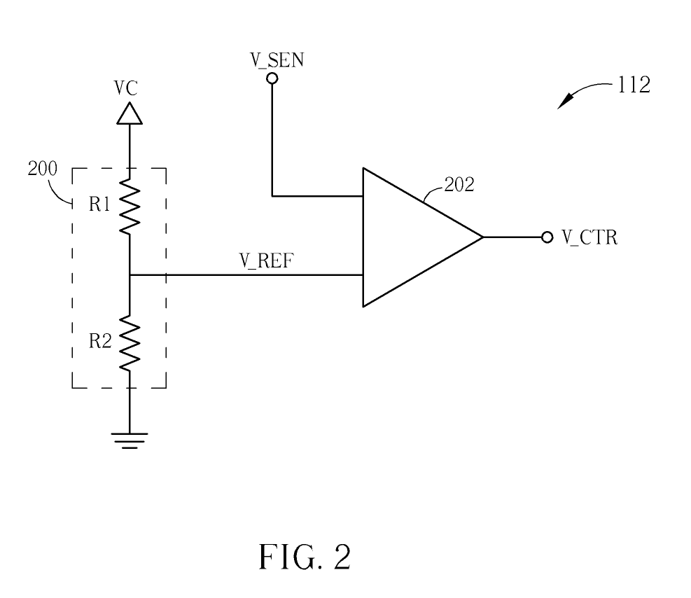

In addition, the power management device 108 is utilized for sensing the current outputted from the power supply 104, so as to determine whether to stop the charger module 102 from charging or reducing CPU speed in other embodiments. Thus, the sensing module 110 is not limited to any formations, as long as it is capable of sensing the current outputted from the power supply 104 and outputting the corresponding sensing signal V_SEN. The sensing signal V_SEN is not limited to any formations either, but depends on the formations of the sensing module 110, which can be a value obtained by analog to digital conversion, or simply an analog signal. Similarly, the control unit 112 is not limited to any formations, as long as being capable of determining whether the power supply 104 approaches overloading according to the sensing signal V_SEN, so as to timely control or indicate the charger module 102 to stop charging. For example, please refer to FIG. 2, which illustrates a schematic diagram of the control unit 112 shown in FIG. 1 according to an embodiment of the invention. In FIG. 2, the control unit 112 comprises a divider circuit 200 and a comparator 202. The divider circuit 200 comprises resistors R1, R2, and serves as a reference signal generator for dividing a voltage VC, to generate a reference signal V_REF. The reference signal V_REF is corresponding to an overloading or near-overloading current of the power supply 104, and the comparator 202 compares the reference signal V_REF and the sensing signal V_SEN. The corresponding comparison result signal is the control signal V_CTR outputted to the charger module 102.

FIG. 2 is an example taking the sensing signal V_SEN as a voltage form. Note that, the presumption herein is that the comparison of the reference signal V_REF and the sensing signal V_SEN can fully reflect whether the power supply 104 approaches overloading. For example, if the sensing signal V_SEN of the power supply 104 when overloading is a 4-volts voltage signal, the reference signal V_REF should be devised as a voltage signal which is equal to or slightly smaller than 4 volts. Besides, if the sensing signal V_SEN is a digitalized value, the control unit 112 should include a value comparator. However, the control unit 112 is utilized for accurately determining whether the power supply 104 approaches overloading, to control or indicate the charger module 102 to timely stop charging; thus, other frameworks and signal generation schemes of the control unit 112 are not limited to particular specifications. For example, the control unit 112 can be integrated into the charger module 102, or further outputs the control signal VCTR via a keyboard controller, micro processors, etc.

Therefore, the power management device 108 provides a proper redress scheme, to increase the flexibility on management. For example, if a laptop adopts the structure of the portable electronic device 10 and includes the power management device 108, when BIOS is not properly configured or a make of an equipped power supply is wrong, e.g. power consumption is configured to 90 watts in the BIOS, while the laptop is equipped with a 65-watt power supply, with the help of the power management device 108, the power management device 108 can control or indicate to stop charging when the system power consumption approaches the maximum power that the power supply can provide, i.e. 65 watts, to reduce the power consumption, and avoid overloading. In comparison, in the same condition, the prior art without the power management device 108 requires rebooting due to the power supply overloading, causing the system crashing.

As can be seen from the above, the invention provides an extra redress scheme, to increase the flexibility on management, and to elevate product competitivity.

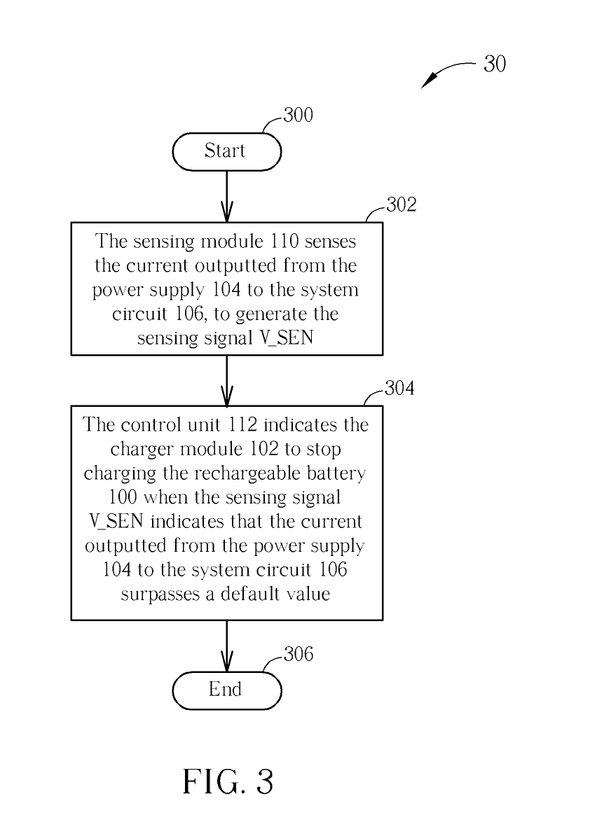

On the other hand, the operations of the power management device 108 can be further generalized as a power management procedure 30, as shown in FIG. 3, including the following steps:

Step 300: Start.

Step 302: The sensing module 110 senses the current outputted from the power supply 104 to the system circuit 106, to generate the sensing signal V_SEN.

Step 304: The control unit 112 indicates the charger module 102 to stop charging the rechargeable battery 100 when the sensing signal V_SEN indicates that the current outputted from the power supply 104 to the system circuit 106 surpasses a default value.

Step 306: End.

Detailed description of power management procedure 30 can be referred to the above, and is not narrated hereinafter for simplicity.

To sum up, the invention provides a redress scheme for a portable electronic device, to increase the flexibility on management when power supply approaches overloading, so as to timely stop charging, to reduce power consumption, hence preventing the system from crashing.

Those skilled in the art will readily observe that numerous modifications and alterations of the device and method may be made while retaining the teachings of the invention.

What is claimed is:

1. A power management device for a portable electronic device, comprising:
a sensing unit, coupled between a power supply and a system circuit of the portable electronic device, for sensing a current outputted from the power supply to the system circuit, to generate a sensing signal; and
a control unit, coupled between the sensing unit and a charger module of the portable electronic device, for indicating the charger module to stop charging when the sensing signal indicates that the current outputted from the power supply to the system circuit is greater than a predetermined value.

2. The power management device for the portable electronic device of claim 1, wherein the control unit comprises:
a reference signal generator, for generating a reference signal corresponding to the predetermined value; and
a comparator, coupled to the reference signal generator and the sensing unit, for comparing the sensing signal with the reference signal, to output a comparison result signal to the charger module, so as to determine whether to stop charging.

3. The power management device for the portable electronic device of claim 2, wherein the reference signal generator is a voltage divider circuit.

4. The power management device for the portable electronic device of claim 2, wherein the comparator is integrated into a keyboard controller.

5. The power management device for the portable electronic device of claim 1, wherein the control unit is integrated into the charger module.

6. A portable electronic device, comprising:
a rechargeable battery, for storing electric energy;
a charger module, for charging the rechargeable battery;
a power supply, for converting an alternating-current power source to a direct-current (DC) power source;
a system circuit, driven by the electric energy stored in the rechargeable battery or the DC power source outputted from the power supply; and
a power management device, comprising:
a sensing unit, coupled between the power supply and the system circuit, for sensing current of the DC power source outputted from the power supply to the system circuit, to generate a sensing signal; and
a control unit, coupled between the sensing unit and the charger module, for indicating the charger module to stop charging the rechargeable battery when the sensing signal indicates that the current outputted from the power supply to the system circuit is greater than a predetermined value.

7. The portable electronic device of claim 6, wherein the control unit comprises:
a reference signal generator, for generating a reference signal corresponding to the predetermined value; and
a comparator , coupled to the reference signal generator and the sensing unit, for comparing the sensing signal with the reference signal, to output a comparison result signal to the charger module, so as to determine whether to stop charging the rechargeable battery.

8. The portable electronic device of claim 7, wherein the reference signal generator is a voltage divider circuit.

9. The portable electronic device of claim 6, wherein the comparator is integrated into a keyboard controller.

10. The portable electronic device of claim 6, wherein the control unit is integrated into the charger module.

11. A method of power management for a portable electronic device, comprising:
sensing current outputted from a power supply of the portable electronic device to a system circuit of the portable electronic device, to generate a sensing signal; and
indicating a charger module of the portable electronic device to stop charging when the sensing signal indicates that the current outputted from the power supply to the system circuit is greater than a predetermined value.

12. The method of power management for the portable electronic device of claim 11, wherein the step of indicating the charger module of the portable electronic device to stop charging when the sensing signal indicates that the current outputted from the power supply to the system circuit is greater than a predetermined value, comprising:
generating a reference signal corresponding to the predetermined value; and
comparing the sensing signal with the reference signal to output a comparison result signal to the charger module, so as to determine whether to stop charging.

13. The method of power management for the portable electronic device of claim 12, wherein the reference signal is generated via voltage dividing.

14. The method of power management for the portable electronic device of claim 11 further comprising:
indicating the system circuit to downgrading an operation frequency of a central processing unit to reduce power consumption of the system circuit when the sensing signal indicates that the current outputted from the power supply to the system circuit is greater than the predetermined value.
